(19) United States
(12) Patent Application Publication
(10) Pub. No.: US 2022/0002986 A1
(43) Pub. Date: Jan. 6, 2022

(54) MULTIFUNCTIONAL SHOWER DEVICE FOR TOP SPRAY AND HANDHELD

(71) Applicant: PRIMY CORPORATION LIMITED, Zhuhai (CN)

(72) Inventors: Jianfa CHEN, Zhuhai (CN); Fei HAO, Zhuhai (CN); Xiaobo LI, Zhuhai (CN); Yong LIU, Zhuhai (CN)

(73) Assignee: PRIMY CORPORATION LIMITED, Zhuhai (CN)

(21) Appl. No.: 17/140,113

(22) Filed: Jan. 3, 2021

(30) Foreign Application Priority Data
Jul. 3, 2020 (CN) 2020106355934

(51) Int. Cl. E03C 1/06

(52) U.S. Cl. CPC E03C 1/066

(57) ABSTRACT

A multifunctional shower device for top spraying and hand holding is disclosed. The top of the shower is provided with a water inlet, and the bottom of the shower is provided with a water outlet panel. One end of the shower hose is connected with a water inlet pipe joint, and the other end of the shower hose is connected with the water inlet on the top of the shower. The shower hose and the movable pulley are placed in the storage shell. Half of the weight of the movable pulley is greater than the weight of the shower. The movable pulley falls naturally under the action of gravity, and the movable pulley drives the shower hose to be stored in the storage shell in a U shape. The bracket is fixed on the storage shell and the shower seat is arranged on the bracket.

### TECHNICAL FIELD

The present disclosure relates to the field of shower equipment, and more specifically, to a multifunctional shower device for top spraying and hand holding.

### BACKGROUND

Currently, the shower equipment on the market generally includes handheld shower and top spray shower, which are two independent parts and used separately.

The top spray shower needs to be fixed on the top spray pipe of the exposed shower rod, or fixed on the wall-mounted top spray pipe, and it takes up more space; the hand-held shower needs to be connected with another water outlet connector with the shower hose, which is hanging in the air, which is easy to touch and entangle, which is quite inconvenient.

### SUMMARY

The present disclosure provides a multifunctional shower device for top spraying and hand holding, which combines the top spray shower function and the hand-held shower function of shower equipment into one, and has both the top spray function and the hand-held shower function, which is beautiful and saves space. At the same time, the shower hose is stored and will not be entangled or obstructed.

The multifunctional shower device for top spraying and hand holding of the present disclosure includes a storage shell, a movable pulley, a shower hose, a shower, a bracket and a shower seat.

The top of the shower is provided with a water inlet, and the bottom of the shower is provided with a water outlet panel.

One end of the shower hose is connected with a water inlet pipe joint, and the other end of the shower hose is connected with the water inlet on the top of the shower.

The shower hose and the movable pulley are placed in the storage shell, and the shower hose bypasses the bottom groove of the movable pulley to make the movable pulley ride on the shower hose.

Half of the weight of the movable pulley is greater than the weight of the shower, and the movable pulley falls naturally under the action of gravity, and at the same time, the movable pulley drives the shower hose to be stored in the storage shell in a U shape.

The bracket is fixed on the storage shell, the shower seat is arranged on the bracket, and the shower is lifted by the shower hose under the drive of the movable pulley to be limited to the shower seat, and the water outlet panel at the bottom of the shower is downward.

Preferably, the storage shell includes a bottom plate, a side plate and a cover plate, and the cover plate is provided with a hose outlet.

Preferably, the front of the bracket is connected with the shower seat, the top of the bracket is provided with an arc groove, the rear of the bracket is provided with a hose opening, and the hose opening is communicated with the hose outlet of the cover plate.

Preferably, the movable pulley is limited in the storage shell, and the movable pulley will not topple in the process of ascending or descending.

Preferably, the shower is provided with a handheld handle and the handheld handle is installed on the side wall of the shower.

Preferably, the top of the shower is provided with a protrusion, the bottom of the shower seat is provided with a groove matched with the protrusion, and the protrusion of the top of the shower is clamped in the groove of the bottom of the shower seat.

The multifunctional shower device for top spraying and hand holding provided by the present disclosure includes storage shell, a movable pulley, a shower hose, a shower, a bracket and a shower seat, wherein the top of the shower is provided with a water inlet, and the bottom of the shower is provided with a water outlet panel; one end of the shower hose is connected with a water inlet pipe joint, and the other end of the shower hose is connected with the water inlet on the top of the shower; the shower hose and the movable pulley are placed in the storage shell, and the shower hose bypasses the bottom groove of the movable pulley to make the movable pulley ride on the shower hose; half of the weight of the movable pulley is greater than the weight of the shower, and the movable pulley falls naturally under the action of gravity, and at the same time, the movable pulley drives the shower hose to be stored in the storage shell in a U shape; the bracket is fixed on the storage shell, the shower seat is arranged on the bracket, and the shower is lifted by the shower hose under the drive of the movable pulley to be limited to the shower seat, and the water outlet panel at the bottom of the shower is downward.

In actual use, when the device is used as top spraying shower, half of the weight of the movable pulley is greater than the weight of the shower, and the movable pulley falls naturally under the action of gravity, and at the same time, the movable pulley drives the shower hose to be stored in the storage shell in a U shape; the shower is lifted by the shower hose under the drive of the movable pulley to be limited to the shower seat, and the water outlet panel at the bottom of the shower is downward. At this time, the position of the shower is relatively fixed at a certain height, and it can be used as a top spraying shower.

In actual use, when the device is used as hand holding shower, the user only needs to grab the shower and pull it down, and it can be used as a handheld shower to spray in any direction. When it is pulled down, the shower hose drives the movable pulley to rise. Since the shower hose is in the groove of the movable pulley, the groove has a guiding effect on the shower hose, so it is easier to use. According to the mechanical principle of the movable pulley, the force of pulling the shower down is only half of the weight of the movable pulley, so it is easy to use the shower as a handheld shower and will not affect the user experience. When the shower is not in use or when the top spraying shower is in use, the shower hose is stored in a U shape in the storage shell, and will not be entangled or obstructed.

Compared with the existing technology, the multifunctional shower device for top spraying and hand holding provided by the present disclosure combines the top spray shower function and the handheld shower function of shower equipment into one, and has both the top spray function and the handheld shower function, which is beautiful and saves space. At the same time, the shower hose is stored and will not be entangled or obstructed.

### BRIEF DESCRIPTION OF THE DRAWINGS

In order to explain the embodiments of the present disclosure or the technical solutions in the prior art more clearly, the following will briefly introduce the drawings that need to be used in the description of the embodiments or the prior art. Obviously, the drawings in the following description are only embodiments of the present disclosure. For those of ordinary skill in the art, other drawings may be obtained according to the provided drawings without creative work.

FIG. 1 is a structural diagram of the multifunctional shower device for top spraying and hand holding in the embodiment of the disclosure, and the figure shows the use state of top spraying.

FIG. 2 is a structural schematic diagram of other angles of the multifunctional shower device for top spraying and hand holding in FIG. 1

FIG. 3 is a structural diagram of the multifunctional shower device for top spraying and hand holding in the embodiment of the disclosure, and the figure shows the use state of hand holding.

FIG. 4 is a schematic diagram of the explosion structure of the multifunctional shower device for top spraying and hand holding in the embodiment of the disclosure.

### DETAILED DESCRIPTION OF EMBODIMENTS

Certain exemplary embodiments will now be described to provide an overall understanding of the principles of the structure, function, manufacture, and use of the instruments and methods disclosed herein. One or more examples of these embodiments are illustrated in the accompanying drawings. Those skilled in the art will understand that the instruments and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

In the description of the disclosure, the terms such as “left”, “right”, “middle”, “front” and “back” indicate the orientation or position relationship based on the attached drawings, which is only for the convenience of describing the disclosure rather than requiring the disclosure to be constructed and operated in a specific orientation, therefore it cannot be understood as a limitation of the disclosure.

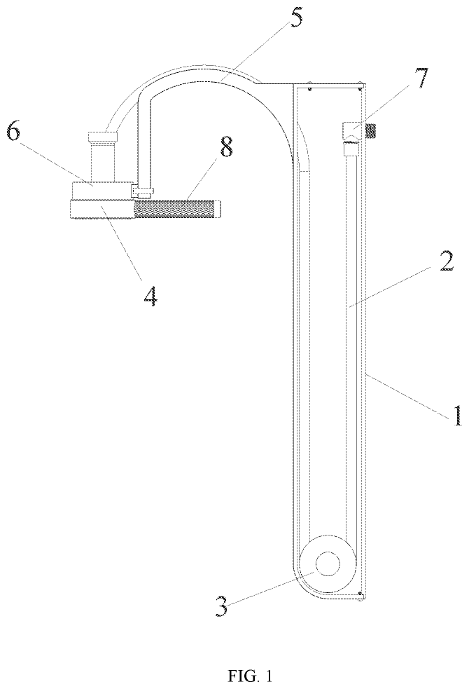

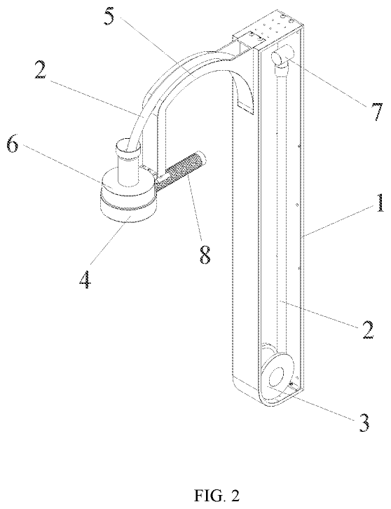

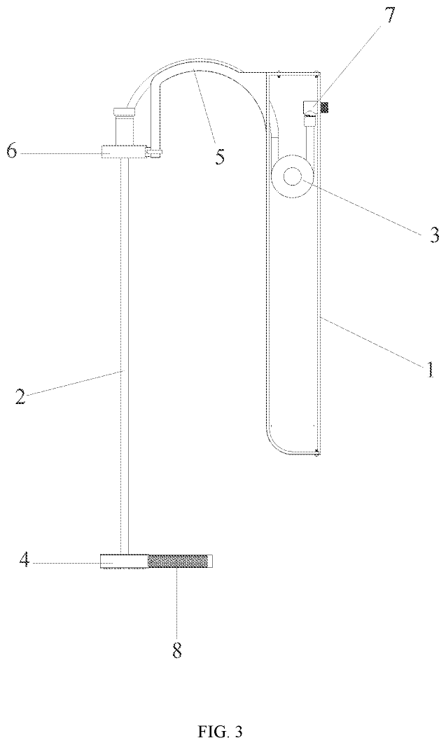

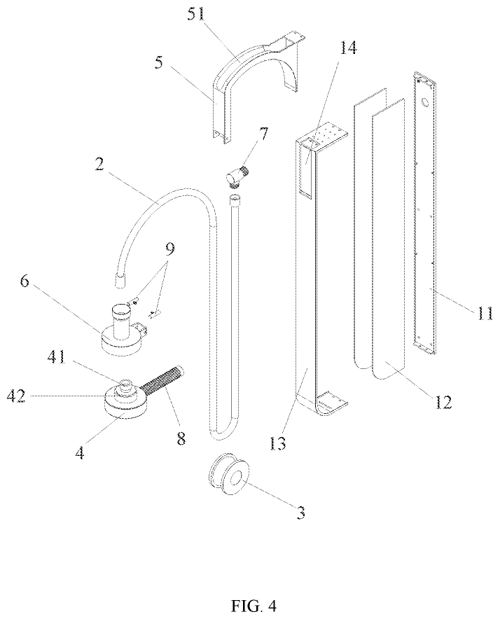

As shown in FIG. 1-FIG. 4, FIG. 1 is a structural diagram of the multifunctional shower device for top spraying and hand holding in the embodiment of the disclosure, and the figure shows the use state of top spraying; FIG. 2 is a structural schematic diagram of other angles of the multifunctional shower device for top spraying and hand holding in FIG. 1; FIG. 3 is a structural diagram of the multifunctional shower device for top spraying and hand holding in the embodiment of the disclosure, and the figure shows the use state of hand holding; FIG. 4 is a schematic diagram of the explosion structure of the multifunctional shower device for top spraying and hand holding in the embodiment of the disclosure.

The present disclosure provides a multifunctional shower device for top spraying and hand holding. The shower device includes a storage shell 1, a movable pulley 3, a shower hose 2, a shower 4, a bracket 5 and a shower seat 6.

The shower 4 is provided with a water inlet 41, and the bottom of the shower 4 is provided with a water outlet panel (not shown in the figures).

One end of the shower hose 2 is connected with a water inlet pipe joint 7, and the other end of the shower hose 2 is connected with the water inlet 41 on the top of the shower 4.

The shower hose 2 and the movable pulley 3 are placed in the storage shell 1, and the shower hose 2 bypasses the bottom groove of the movable pulley 3 to make the movable pulley 3 ride on the shower hose 2.

Half of the weight of the movable pulley 3 is greater than the weight of the shower 4, and the movable pulley 3 falls naturally under the action of gravity, and at the same time, the movable pulley 3 drives the shower hose 2 to be stored in the storage shell 1 in a U shape.

The bracket 5 is fixed on the storage shell 1, the shower seat 6 is arranged on the bracket 5, and the shower 4 is lifted by the shower hose 2 under the drive of the movable pulley 3 to be limited to the shower seat 6, and the water outlet panel at the bottom of the shower 4 is downward.

The storage shell 1 includes a bottom plate 11, a side plate 12 and a cover plate 13, and the cover plate 13 is provided with a hose outlet 14.

The front of the bracket 5 is connected with the shower seat 6 by bolts 9, the top of the bracket 5 is provided with an arc groove 51, the rear of the bracket 5 is provided with a hose opening (not shown in the figures), and the hose opening is communicated with the hose outlet 14 of the cover plate 13.

The movable pulley 3 is limited in the storage shell 1, and the movable pulley 3 will not topple in the process of ascending or descending.

The shower hose 2 sags naturally under the action of the gravity of the movable pulley 3, and under the guidance of the groove of the movable pulley 3 and the arc groove 51 of the bracket 5, it will not be entangled with each other, and is basically hidden in the storage box without inconvenience. When the shower 4 is pulled up, the shower hose 2 will not deviate under the guidance of the groove of the movable pulley 3 and the arc groove 51 of the bracket 5.

The shower 4 is provided with a handheld handle 8 and the handheld handle 8 is installed on the side wall of the shower 4. It is convenient for the user to hold the shower through the handheld handle 8.

The top of the shower is provided with a protrusion 42, the bottom of the shower seat 6 is provided with a groove (not shown in the figures) matched with the protrusion 42, and the protrusion 42 of the top of the shower 4 is clamped in the groove of the bottom of the shower seat 6.

In actual use, when the device is used as top spraying shower, half of the weight of the movable pulley is greater than the weight of the shower, and the movable pulley falls naturally under the action of gravity, and at the same time, the movable pulley drives the shower hose to be stored in the storage shell in a U shape; the shower is lifted by the shower hose under the drive of the movable pulley to be limited to the shower seat, and the water outlet panel at the bottom of the shower is downward. At this time, the position of the shower is relatively fixed at a certain height, and it can be used as a top spraying shower.

In actual use, when the device is used as hand holding shower, the user only needs to grab the shower and pull it down, and it can be used as a handheld shower to spray in any direction. When it is pulled down, the shower hose drives the movable pulley to rise. Since the shower hose is in the groove of the movable pulley, the groove has a guiding effect on the shower hose, so it is easier to use. According to the mechanical principle of the movable pulley, the force of pulling the shower down is only half of the weight of the movable pulley, so it is easy to use the shower as a handheld shower and will not affect the user experience. When the shower is not in use or when the top spraying shower is in use, the shower hose is stored in a U shape in the storage shell, and will not be entangled or obstructed.

Compared with the existing technology, the multifunctional shower device for top spraying and hand holding provided by the present disclosure combines the top spray shower function and the handheld shower function of shower equipment into one, and has both the top spray function and the handheld shower function, which is beautiful and saves space. At the same time, the shower hose is stored and will not be entangled or obstructed.

Described above are merely illustrative of the disclosure to enable those skilled in the art to implement or use the disclosure, and are not intended to limit the invention. It should be understood that any modifications, replacements or changes made by those skilled in the art without departing from the spirit of the disclosure should fall within the scope of the disclosure.

What is claimed is:

1. A multifunctional shower device for top spray and hand holding, comprising a storage shell, a movable pulley, a shower hose, a shower, a bracket and a shower seat; wherein the top of the shower is provided with a water inlet, and the bottom of the shower is provided with a water outlet panel;
one end of the shower hose is connected with a water inlet pipe joint, and the other end of the shower hose is connected with the water inlet on the top of the shower;
the shower hose and the movable pulley are provided in the storage shell; the shower hose bypasses the bottom groove of the movable pulley to make the movable pulley ride on the shower hose;
half of the weight of the movable pulley is greater than the weight of the shower; the movable pulley naturally descends under the action of gravity, and at the same time, drives the shower hose to be stored in the storage shell in a U-shape;
the bracket is fixedly provided on the storage shell, the shower seat is arranged on the bracket, and the shower is lifted by the shower hose under the drive of the movable pulley to be limited to the shower seat, and the water outlet panel at the bottom of the shower is downward.

2. The shower device of claim 1, wherein the storage shell comprises a bottom plate, a side plate and a cover plate, and the cover plate is provided with a hose outlet.

3. The shower device of claim 2, wherein the front of the bracket is connected with the shower seat, the top of the bracket is provided with an arc groove, the rear of the bracket is provided with a hose opening, and the hose opening is communicated with the hose outlet of the cover plate.

4. The shower device of claim 1, wherein the movable pulley is limited in the storage shell, and the movable pulley will not topple in the process of ascending or descending.

5. The shower device of claim 1, wherein the shower is provided with a handheld handle and the handheld handle is installed on the side wall of the shower.

6. The shower device of claim 5, wherein the top of the shower is provided with a protrusion, the bottom of the shower seat is provided with a groove matched with the protrusion, and the protrusion of the top of the shower is clamped in the groove of the bottom of the shower seat.
